(19) United States
(12) Patent Application Publication
(10) Pub. No.: US 2012/0171529 A1
(43) Pub. Date: Jul. 5, 2012

(54) BATTERY PACK

(76) Inventors: Yasunari Sugita, Osaka (JP); Tomohiko Yokoyama, Osaka (JP); Keisuke Shimizu, Osaka (JP); Masato Fujikawa, Osaka (JP)

(21) Appl. No.: 13/496,376

(22) PCT Filed: Jun. 14, 2011
(86) PCT No.: PCT/JP2011/003373

§ 371 Date: Mar. 15, 2012

(30) Foreign Application Priority Data
Jul. 13, 2010 (JP) 2010158763

(51) Int. Cl. H01M 10/50

(52) U.S. Cl. 429/62

(57) ABSTRACT

Disclosed is a battery pack including a battery and a cooling member for cooling the battery. The cooling member includes a coolant and a container enclosing the coolant. The container is capable of having a releasing port for releasing the coolant at a first temperature of 100° C. or more. The cooling member is arranged at a position that allows the coolant released from the releasing port of the container to spread on a principal surface of the battery. The coolant may include water, a surfactant, and a metallic soap. The coolant may further include a foaming accelerator capable of foaming at a temperature of 100° C. or more.

### RELATED APPLICATIONS

This application is the U.S. National Phase under 35 U.S.C. §371 of International Application No. PCT/JP2011/003373, filed on Jun. 14, 2011, which in turn claims the benefit of Japanese Application No. 2010-158763, filed on Jul. 13, 2010, the disclosures of which Applications are incorporated by reference herein.

### TECHNICAL FIELD

The present invention relates to a battery pack including a battery and a battery cooling member, and particularly relates to an improvement of the cooling performance of the battery cooling member.

### BACKGROUND ART

Recently, with the widespread use of various electronic devices, there is an increasing demand for primary batteries and secondary batteries to be used as a power source therefor. For example, for use in portable devices such as notebook personal computers and cellular phones, secondary batteries being small in size and light in weight and high in energy density, and being capable of repeated charge and discharge are increasingly demanded. Further, with regard to secondary batteries, there is a growing demand recently for use as a driving power source for electric power tools, hybrid cars, and electric vehicles. In order to meet such demand, research and development for non-aqueous electrolyte secondary batteries represented by lithium ion secondary batteries are actively carried out.

Further, development is in progress for a battery pack or battery assembly with high capacity and high output, in which one or more batteries, together with a circuit or the like, are accommodated in a housing or bound together.

As the performance and output of the devices are improved, the energy to be possessed by the batteries is increasing, and in association therewith, the quantity of heat to be generated in the event of abnormality is increasing. The abnormal heat generation of the battery refers to, for example, heat generation in the event of internal short-circuiting or overcharging of the battery.

Under these circumstances, also with respect to the battery pack accommodating these batteries, it is important to ensure the safety thereof.

For example, Patent Literature 1 discloses a battery pack including a sheet-like secondary battery which includes a sheet-like power generating element and a resin package enclosing the power generating element, and a housing accommodating the secondary battery. Patent Literature 1 teaches that a frame-like fire extinguishing member be arranged at a thermally welded portion of the package, the portion formed around the power generating element. The fire extinguishing member comprises a polyethylene container and a fire extinguishing agent being enclosed in the container and including a mixture of ammonium dihydrogen phosphate, ammonium sulfate, and silicon dioxide. When the battery generates heat abnormally, the container is heated and melts, and the fire extinguishing agent is released outside the container.

### CITATION LIST

### Patent Literature

[PTL 1] Japanese Laid-Open Patent Publication No. 2009-99322

### SUMMARY OF INVENTION

### Technical Problem

However, in Patent Literature 1, the fire extinguishing member is arranged around the end of the power generating element and is sandwiched between the end of the power generating element and the housing. As such, even though the fire extinguishing agent is released outside the container in the event of abnormal heat generation of the power generating element, the fire extinguishing agent is merely distributed over a limited area, i.e., an area near the end of the power generating element, and therefore, it is difficult to efficiently suppress the abnormal heat generation of the battery. If the abnormal heat generation of the power generating element occurs locally due to internal short circuiting or the like, at an area away from the fire extinguishing member, such as an area near the center of the principal surface of the sheet-like power generating element, it is difficult to quickly suppress the heat generation at the area. It is impossible, therefore, to sufficiently ensure the safety.

### Solution to Problem

The present invention intends to provide a battery pack in which if abnormal heat generation occurs in a battery, the battery can be cooled efficiently.

One aspect of the present invention is a battery pack or battery assembly including at least one battery and a cooling member for cooling the battery, wherein the cooling member includes a coolant and a container enclosing the coolant, the container is capable of having a releasing port for releasing the coolant at a first temperature of 100° C. or more, and the cooling member is arranged at a position that allows the coolant released from the releasing port of the container to spread on a principal surface of the battery.

### Advantageous Effects of Invention

According to the present invention, it is possible to provide a highly safe and reliable battery pack in which if abnormal heat generation occurs in a battery, the battery can be cooled quickly.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A top view of a battery pack according to one embodiment of the present invention.

FIG. 2 A longitudinal cross-sectional view taken along the line II-II in FIG. 1.

FIG. 3 An oblique view schematically showing a cooling member 5a in FIGS. 1 and 2.

FIG. 4 A side view for explaining an exemplary arrangement of a prismatic battery and the cooling member.

FIG. 5 A side view for explaining an exemplary arrangement of a battery group and the cooling member.

FIG. 6 A side view for explaining an exemplary arrangement of a pouch battery and the cooling member.

### DESCRIPTION OF EMBODIMENTS

The present invention relates to a battery pack including at least one battery and a cooling member for cooling the battery. The cooling member includes a coolant and a cooling container enclosing the coolant. The coolant includes, for example, a surfactant, water, and a metallic soap.

The cooling container is capable of having a releasing port for releasing the coolant at a first temperature of 100° C. or more. The cooling member is arranged at a position that allows the coolant released from the releasing port of the container to spread on a principal surface of the battery.

The battery may further include a housing accommodating the battery and the cooling member. In the case where the battery pack does not include the housing, the battery and the cooling member may be securely bonded or bundled to each other.

When the battery generates heat abnormally, the cooling container is locally heated at a point being in contact with or near the battery. At a first temperature of 100° C. or more, a releasing port for releasing the coolant is formed at least a part of the cooling container. The releasing port may be formed as a consequence of puncture, breakage or rupture of the cooling container. Alternatively, the cooling container may be provided with a vent or a thin-wall portion beforehand. In this case, the releasing port may be formed as a consequence of opening of the vent or rupturing of the thin-wall portion.

The forming mechanism of the releasing port is not particularly limited. For example, the releasing port in the cooling container is formed when the container melts at a point in contact with or near the battery. The port becomes wider as the container is shrunk by heat. Alternatively, in the event where the cooling member is heated by the battery having generated heat abnormally, and the water in its interior evaporates into water vapor, the internal pressure in the cooling container increases, and a portion of the container such as a thin-wall portion ruptures, or a vent opens, forming the releasing port.

The formation of the releasing port occurs instantaneously by the rupturing of the cooling container or the opening of the vent. The releasing port thus formed allows the coolant to be released from the cooling container, and spread on the principal surface of the battery. Since the container is heated and the pressure therein is increased, the coolant spouts out toward the battery, and therefore, the principal surface of the battery can be coated over a large area with a film of the coolant. As such, even if heat generation occurs locally in the battery, the battery can be quickly and efficiently cooled.

It is preferable that the coolant is released so as to spread on the principal surface of the battery over an area as large as possible. The released coolant preferably spreads such that it covers at least 25% or more, preferably 30% or more, and more preferably 35% or more of the total surface area of the battery.

A battery pack according to one embodiment of the present invention is described below with reference to drawings appended hereto. It should be noted, however, that the present invention is not limited to the embodiment below.

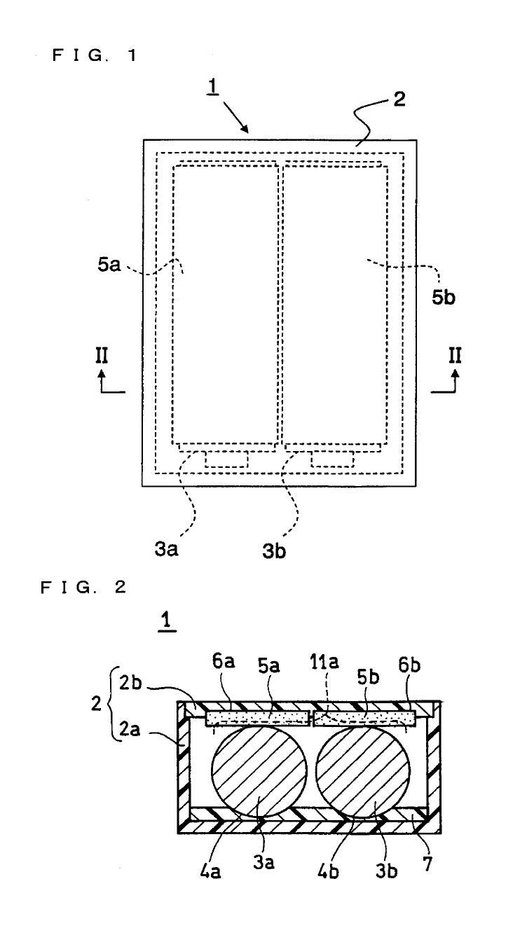

As shown in FIGS. 1 and 2, a battery pack 1 includes batteries 3a and 3b which are cylindrical non-aqueous electrolyte secondary batteries, sheet-like cooling members 5a and 5b which are arranged in contact with the side surfaces of the batteries 3a and 3b along the axis directions thereof and positioned on the batteries 3a and 3b, and a housing 2 accommodating the batteries 3a and 3b and the cooling members 5a and 5b. The battery pack 1 further includes a member (not shown) for electrically connecting the battery 3a to the battery 3b, and a terminal member (not shown) for taking electricity outside the battery pack 1.

The batteries 3a and 3b are aligned in a row and apart from each other with the axis directions thereof being parallel to each other, such that the axis directions thereof are almost perpendicular to the vertical direction.

The housing 2 has a bottomed prismatic tubular case body 2a with a shallow bottom, and a square plate-like lid 2b covering the opening of the case body. The opening end of the case body 2a is provided with a step, and the peripheral portion of the lid 2b is fitted to the step. The fitted portion is thermally welded, whereby the case body 2a and the lid 2b are integrated into one unit. On the inner bottom surface of the case body 2a, a resin member 7 having concaves each corresponding to the shape of the battery is provided so that the batteries can be positioned stably, and the side surfaces of the batteries can be in contact with the cooling member. On the inner surface of the lid 2b, recesses 6a and 6b for holding the cooling members 5a and 5b are provided.

The cooling members 5a and 5b are arranged between the batteries 3a and 3b and the housing 2 so as to be sandwiched between the lid 2b of the housing 2 and the side surfaces of the batteries 3a and 3b. The lid of the housing 2 is in the upper portion of the battery pack 1 or above the batteries 3a and 3b, and accordingly, the cooling members 5a and 5b are arranged above or on the batteries 3a and 3b. In view of the space in the housing and the cooling effect, the thickness of the cooling members 5a and 5b placed between the lid 2b of the housing 2 and the side surfaces of the batteries 3a and 3b is preferably 0.5 to 5 mm.

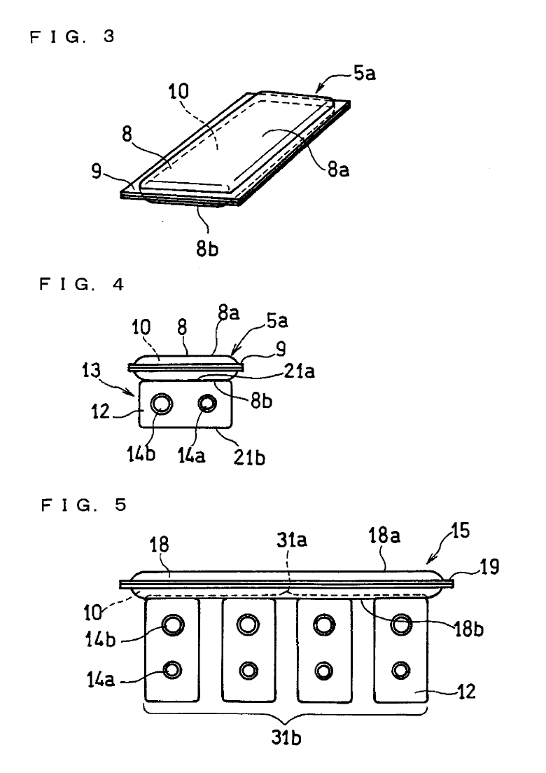

The cooling members 5a and 5b have the same structure. The structure of the cooling member 5a is described below with reference to FIG. 3. The cooling member 5a includes a coolant 10 including water, a surfactant, and a metallic soap, and a cooling container 8 accommodating the coolant. The cooling container 8 is formed of a pouch body obtained by joining the peripheral portions of two resin films. Reference numeral 9 in FIG. 3 denotes a jointed portion. The coolant 10 is enclosed in the pouch body. The central portion surrounded by the peripheral portion has a thickness increased by the enclosure of the coolant 10, and has a pair of wide flat surfaces 8a and 8b. These flat surfaces 8a and 8b are the principal surfaces of the cooling container 8. Of the pair of principal surfaces, the principal surface 8b is in contact with a principal surface 11a of the battery 3a as shown in FIG. 2.

The mechanism for improving the safety of the battery pack is described below.

When the battery 3a generates heat abnormally, the heat is transferred to the cooling member 5a, and the cooling member 5a is heated. As the cooling member 5a is heated, part of the water in the cooling member 5a evaporates into water vapor, and in association therewith, the cooling member 5a expands and bubbles start generating in the cooling member 5a. When the cooling member 5 reaches a first temperature of 100° C. or more, the cooling member 5a starts melting from the portion being in contact with the battery 3a, and ruptures open. At this time, since the cooling member 5a is sandwiched between the battery 3a and the housing 2, the contact area between the cooling member 5a and the battery 3a increases as the cooling member 5a expands. As such, the heat of the battery having generated heat abnormally is transferred sufficiently to the cooling member 5a, allowing the cooling member 5a to rupture open widely. In addition, since the rupture occurs following the expansion, the coolant spouts out toward the battery upon rupture of the cooling member 5a. As a result, the coolant immediately covers the surface of the battery 3a, forming a water film. The water is evaporated by the heat on the surface of the battery 3a, and the latent heat of evaporation deprives the battery 3a of heat. Since the coolant includes, in addition to water, a surfactant and a metallic soap, the water film is formed stably. Due to the inclusion of a surfactant, bubbles are successively formed on the surface of the water film in association with the vaporization of water. Accordingly, even if water attached to the surface of the battery 3a has been evaporated, the water at the bubble surface is supplied to the surface of the battery 3a. As such, the water film is formed without being interrupted, and the water film can be maintained stably.

As a result of the foregoing, the battery 3a having generated heat abnormally can be cooled efficiently and quickly. Further, the heat of the battery 3a having generated heat abnormally can be prevented from being transmitted to the battery 3b. In the case where the battery 3b generates heat abnormally, the battery 3b can be cooled efficiently and quickly by the cooling member 5b.

The battery pack may include one or more batteries. In the case of including two or more batteries, the batteries may be aligned in a row in an appropriate arrangement, or bundled into a battery assembly. In the case of aligning two or more batteries, for example, the batteries are spaced apart from each other with the side surfaces of the adjacent batteries facing each other. Preferably, for example, the batteries are aligned in a row with a predetermined clearance therebetween, with the axis directions of the batteries being parallel to each other. In such an arrangement, even when one of the batteries generates heat abnormally, it is possible to delay the transmission of the heat to the adjacent batteries.

The battery includes, for example, a power generating element including a positive electrode, a negative electrode, and a separator, and a housing accommodating the power generating element and being made of a bottomed tubular metal case or laminated sheet. When abnormal heat generation occurs inside the battery, the heat is diffused through the housing, regardless of the point where the heat has been generated, and the heat is transferred rapidly to the cooling member disposed in contact or proximity with the housing.

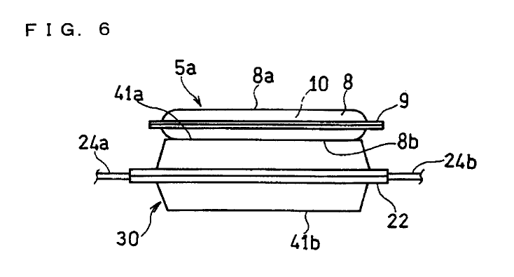

The battery may be, for example, a cylindrical battery, a prismatic battery, a coin battery, or a pouch battery including a power generating element wrapped with laminated sheet. The cylindrical battery has a cylindrical battery body, a positive electrode terminal formed on one end surface thereof, and a negative electrode terminal formed on the other end surface thereof. The prismatic battery has, as shown in FIGS. 4 and 5, a prismatic battery body 13, positive and negative electrode terminals 14a and 14b formed on one end surface thereof, in which the positive electrode terminal 14a and the negative electrode terminal 14b are disposed so as not to electrically contact with each other. In each of the cylindrical and prismatic batteries, the area of an end surface 12 is smaller than that of a side surface of the battery body 13. The side surface of the battery body refers to a surface thereof other than the both end surfaces. The pouch battery includes, as shown in FIG. 6, a pouch body 30 made of laminated sheets with a jointed portion 22 formed at the peripheral portion thereof where the laminated sheets are jointed to each other. From part of the jointed portion 22, a positive electrode lead 24a and a negative electrode lead 24b are extended outside so as not to electrically contact with each other. The central portion surrounded by the peripheral portion is thicker than the peripheral portion due to the presence of a power generating element enclosed therein, and has a pair of large and almost flat surfaces 41a and 41b.

The principal surface of the battery refers to: in the cylindrical battery, the side surface of the cylindrical battery body; and in the prismatic battery, usually, a pair of the flat surfaces 21a and 21b each of which is the largest of the side surfaces of the prismatic battery body 13, as shown in FIG. 4. In the coin battery, it refers to a pair of circular surfaces. In the pouch battery, it refers to a pair of the flat surfaces 41a and 41b, as shown in FIG. 6.

In the battery or battery assembly including two or more batteries aligned with the side surfaces facing each other, a pair of surfaces 31a and 31b each of which is the largest in the aligned or bundled battery group is referred to as the principal surface of the battery, as shown in FIG. 5.

The cooling member is arranged such that the principal surface of the battery can be immediately and widely coated with a film of the coolant, such as a water film including a surfactant and a metallic soap.

The cooling member may not be in direct contact with the principal surface of the battery and may be arranged near the principal surface of the battery, as long as the coolant can widely cover the principal surface of the battery. However, in order to allow the cooling member to effectively respond to abnormal heat generation in the battery so that the releasing port can be formed immediately, the cooling member is preferably in contact with the principal surface of the battery. It is preferable to arrange the cooling member such that the principal surface of the cooling member, that is, the principal surface of the cooling container is parallel to and in contact with the principal surface of the battery. In this case, by arranging such that a straight line being perpendicular to the principal surface of the cooling container and passing through the center of gravity of the battery crosses the principal surface of the cooling container, almost all surface of the battery can be readily covered with a film of the coolant.

The principal surface of the cooling container forms an angle of, for example, 80 to 110°, and preferably 85 to 100°, with respect to the vertical direction.

For example, when used with the prismatic battery, the cooling member 5a is arranged such that, as shown in FIG. 4, the principal surface 8b of the cooling container is parallel to and in contact with the principal surface 21a of the battery. Further, when used with the pouch battery, the cooling member 5a is arranged such that, as shown in FIG. 6, the principal surface 8b of the cooling container is parallel to and in contact with the principal surface 41a of the battery.

The cooling member may be arranged along the contour of the side surface of the battery. By arranging in this way, the cooling member can more effectively respond to abnormal heat generation in the battery so that the releasing port can be formed immediately. For example, when used with the cylindrical battery, the principal surface of the cooling container may be in line contact or in surface contact along the side surface of the battery.

When used with the battery group including two or more batteries aligned, one cooling member may be arranged on the principal surface of each of the batteries, or one cooling member may be arranged in proximity with the principal surface of the battery group. Alternatively, the cooling member may be arranged in the space between the batteries adjacent to each other. In this case, it is possible to cool both of the adjacent batteries as well as to insulate the adjacent batteries from each other. Even if one of the adjacent batteries generates heat abnormally, the heat is unlikely to be transmitted to the other battery.

In the battery group, the cooling member may be disposed between the batteries adjacent to each other. In this case, both of the adjacent batteries can be cooled by one cooling member, and the cooling member can serve as an insulator for insulating the adjacent batteries from each other.

Although in the embodiment shown in FIGS. 1 and 2, the sheet-like cooling member 5a is in contact with the battery 3a at one point thereon, it may be in contact therewith at two or more points. For example, the sheet-like cooling member may be folded into an L-shape, and brought into contact with the battery at two points.

The cooling member is preferably arranged so as to cover the entire principal surface of the battery. In the case where two or more batteries are aligned, one cooling member may be arranged so as to cover the entire principal surface of the battery group. Specifically, as shown in FIG. 5, one cooling member 15 is arranged so as to cover the entire principal surface 21a of a battery group including aligned prismatic batteries. The cooling member 15 is identical to the cooling member 5a except for the size and shape. Specifically, the cooling member 15 includes the cooling container 18 having the shape of a pouch body, and the coolant 10 enclosed therein. The cooling container 18 is composed of two sheets of resin film stacked one on the other, and has a jointed portion 19 at the peripheral portion thereof, and a pair of principal surfaces 18a and 18b each being a large flat surface, at the central portion surrounded by the peripheral portion. By covering the entire surface of the battery with the cooling member, it is possible to allow the cooling member to more effectively respond to abnormal heat generation in the battery, and thus to allow the coolant to adhere to the principal surface of the battery over a large area.

In view of achieving highly efficient cooling, the cooling member is preferably arranged such that, in normal use, it is positioned vertically above or on the battery, and the principal surface of the cooling container is in contact with the principal surface of the battery. The position vertically above or on the battery refers to a position above or on the battery placed with the axis direction thereof being perpendicular to the vertical direction. By arranging the cooling member vertically above or on the battery, it is possible to effectively release the coolant and allow the coolant to adhere to the battery surface. Therefore, even though the content of the coolant is small, the coolant can be effectively spread over the principal surface of the battery.

Although in FIGS. 1 and 2, a recess for fixing the cooling member onto the inner surface of the lid is provided, the shape of the lid and the method of fixing the cooling member are not limited thereto. The cooling member may be fixed by being sandwiched between a plate-like lid having no recess and the battery.

The cooling container is not particular limited as long as the coolant can be accommodated therein, and may be, for example, a pouch body or a box body.

The cooling container may be made of any material that enables formation of the releasing port at a first temperature of 100° C. or more, which is a temperature at which the battery generates heat abnormally. Such a material may be, for example, a material which disables the cooling container to maintain its shape at least a part thereof at the first temperature of 100° C. or more, such as a material that melts or shrinks by heat at such a temperature, or a material that is low in elasticity and ruptures easily.

The cooling container is preferably formed of a film of a resin material having properties as above. Examples of the resin constituting such film include: polyolefins, such as polypropylene and polyethylene; polyesters, such as polyethylene terephthalate; polyamides; and polyimides. Among these, polypropylene and polyethylene terephthalate are preferable in view of the durability and costs. The thickness of the resin film is preferably 0.02 to 1 mm in view of the balance between the strength as the container and the reliable formation of the releasing port.

Alternatively, the cooling container may be formed of a laminated film comprising a metal layer such as an aluminum layer sandwiched between the resin films as mentioned above. In this case, the resin film is preferably a film of polyolefin, polyethylene terephthalate or polyamide. A preferable thickness of the laminated film is, for example, 50 to 500 μm.

Although in FIG. 3, one coolant is enclosed in one space in the cooling container, two or more spaces may be formed in the cooling container by providing a partition wall therein of, for example, thermoplastic resin, such as a partition wall of the resin film as mentioned above. The same coolant may be enclosed in all of the spaces in the cooling container, or the components and mixing ratio thereof of the coolant may be changed according to the space.

The principal component of the coolant is water. Water is non-inflammable liquid, and its latent heat of evaporation is high. Due to its high evaporation heat, water exhibits excellent cooling capability.

Water has a high surface tension and, therefore, the wetting thereof with respect to the battery housing made of metal or resin is low. Even if water adheres to the surface of the housing, it becomes water droplets, whose contact area with the housing is small. In order to cool the battery efficiently, it is desirable to add a surfactant to the water. By adding a surfactant, the surface tension can be lowered, and the wetting of water with respect to the battery surface can be improved. Further, the contact area between the water and the housing can be increased, and hence, even though the content of water is small, a water film can be formed on the battery surface, which enables efficient cooling.

In addition, due to the action of the surfactant, bubbles are successively formed on the water film as the water in the water film evaporates, allowing water for forming bubbles to be supplied to the battery surface even if the water on the battery surface has been evaporated. As such, the water film is formed without being interrupted over a long period of time, and the state in which the water film is present is maintained. Therefore, the battery can be efficiently and continuously cooled. Moreover, the coolant adhering to the battery surface further spreads while foaming, on the battery surface, and therefore, the battery can be cooled more effectively.

The surfactant included in the coolant is soluble in water, and in this point, is different from a metallic soap which is hardly soluble in water.

The surfactant has, in the molecule thereof, a hydrophilic group and a hydrophobic group. The hydrophilic group includes, for example, a long-chain aliphatic hydrocarbon group or an aromatic hydrocarbon group, the group having 8 to 20 carbon atoms and preferably having 8 to 16 carbon atoms. The long-chain aliphatic hydrocarbon group may be, for example, a saturated or unsaturated chain hydrocarbon group, such as alkyl group, alkenyl group, or alkadienyl group. The chain hydrocarbon group is preferably a straight-chain hydrocarbon group. The aromatic hydrocarbon group may be, for example, a C₆₋₁₂ aryl group, such as phenyl group or naphthyl group; or a straight-chain C₁₋₁₀ alkyl C₆₋₁₂ aryl group, such as tolyl group or octylphenyl group.

The surfactant is selected according to the type of the hydrophilic group, and may be either one of an anionic surfactant, a cationic surfactant, a nonionic surfactant, and an amphoteric surfactant. These surfactants may be used singly, or in combination of two or more.

Among these, an anionic surfactant is particularly preferable.

The hydrophilic group of the anionic surfactant is preferably at least one selected from the group consisting of carboxyl group, sulfonic acid group, sulfuric acid ester groups, phosphoric acid ester groups, and salts thereof. Examples of the salt include alkali metal salts such as potassium salts and sodium salts, amine salts, and ammonium salts.

A carboxylic acid-type surfactant having carboxyl group or a salt thereof is exemplified by a higher fatty acid or a salt thereof. In this case, the hydrophobic group of the surfactant is a residue of higher fatty acid. The higher fatty acid is preferably a saturated or unsaturated fatty acid having 10 to 20 carbon atoms and preferably having about 12 to 18 carbon atoms. Examples of the higher fatty acid include lauric acids, myristic acids, palmitic acids, oleic acids, and stearic acids. Among various carboxylic acid-type surfactants, alkali metal salts of higher fatty acid, particularly, K or Na salts thereof are preferred. These carboxylic acid-type surfactants may be used singly or in combination of two or more. Alternatively, two or more salts of different higher fatty acids may be used in combination. In the case of using a lauric acid salt, foaming is excellent. In the case of using a myristic acid salt, fine bubbles are formed, and good foam stability is achieved. In the case of using a palmitic acid salt, foaming is poor, but fine and stable bubbles are formed even in a high temperature environment. In the case of using an oleic acid salt, which is low in surface tension, the wetting can be greatly improved.

A sulfonic acid-type surfactant having sulfonic acid group or a salt thereof is exemplified by an alkyl sulfonic acid (e.g., straight-chain C₈₋₁₆ alkyl sulfonic acid), aryl sulfonic acid, alkyl aryl sulfonic acid, or a salt of these acids. A sulfuric acid ester-type surfactant having a sulfuric acid ester group or a salt thereof is exemplified by a monoalkyl sulfuric acid ester (e.g., straight-chain C₈₋₁₆ alkyl sulfuric acid ester), polyoxyethylene alkyl ether sulfuric acid ester, polyoxyethylene alkyl aryl ether sulfuric acid ester, or a salt of these esters. A phosphoric acid ester-type surfactant having a phosphoric acid ester group or a salt thereof is exemplified by a monoalkyl phosphoric acid ester (e.g., straight-chain C₈₋₁₆ alkyl phosphoric acid ester), or a salt thereof. In these surfactants, the alkyl, aryl and alkyl aryl portions each correspond to the above-mentioned hydrophobic group. Among these, an alkyl sulfonic acid or an alkali metal salt (e.g., Na salt or Ka salt) thereof is preferred because of its excellent foaming ability.

The content of the surfactant in the coolant is, for example, 0.1 to 20 parts by weight, preferably 0.3 to 15 parts by weight, and more preferably 0.5 to 10 parts by weight per 100 parts by weight of water. When the content of the surfactant in the coolant is 0.1 part by weight or more per 100 parts by weight of water, the surface tension of the coolant is effectively lowered, and the formation of water film is facilitated. When the content of the surfactant in the coolant is 20 parts by weight or less per 100 parts by weight of water, a large amount of water can be enclosed, and therefore, the cooling effect by water is sufficiently exerted.

Preferably, the coolant further includes a metallic soap. By using such a coolant, it is possible to effectively suppress the coolant adhering to the surface of the battery from flowing downward along the surface of the battery, thereby to maintain the cooling effect by water over a long period of time. The inclusion of a metallic soap which has very strong adhesiveness allows the water film to strongly adhere to the battery surface, and thus to be more likely to be held on the battery surface. In addition, the inclusion of a metallic soap can further enhance the wetting of the water film containing the surfactant. Consequently, the cooling effect by water can be sufficiently maintained over a long period of time, and the battery can be efficiently cooled with a small amount of coolant.

A metallic soap is a salt of a higher fatty acid with a metal other than sodium and potassium. The metallic soap is preferably a salt of a higher fatty acid with a metal other than alkali metals.

Examples of the higher fatty acid are those as exemplified in the above section of the carboxylic acid-type surfactant. Examples of the metal include alkaline-earth metals such as calcium and magnesium, and zinc. These metallic soaps may be used singly, or in combination of two or more.

Among these, a stearic acid salt or lauric acid salt is more preferable in view of the stability of the water film.

The metallic soap may be formed of a higher fatty acid being a component of the surfactant, and a mineral component such as calcium or magnesium contained in water. For the mineral component, a mineral component contained in, for example, tap water, may be utilized, but in order to more reliably form a metallic soap containing a mineral component at a predetermined concentration, it is preferable to add a mineral component to water. The mineral component is exemplified by a water-soluble salt or compound, and is specifically, for example, a water-soluble Ca or Mg salt, or a water-soluble halide such as CaCl₂ or MgCl₂. These mineral components may be used singly or in combination of two or more.

The content of the metallic soap in the coolant is for example, 0.01 to 5 parts by weight per 100 parts by weight of water. When the content of the metallic soap in the coolant is 0.01 part by weight or more per 100 parts by weight of water, the water film is allowed to adhere to the battery surface more stably. When the content of the metallic soap in the coolant is 5 parts by weight or less per 100 parts by weight of water, an appropriate degree of fluidity can be imparted to the coolant, and the coolant is more readily distributed over the entire surface of the battery.

In order to greatly improve the stability of the water film, the content of the metallic soap in the coolant is more preferably 0.02 to 5 parts by weight per 100 parts by weight of water, and furthermore preferably 0.5 to 5 parts by weight per 100 parts by weight of water.

In the case where the battery pack is used in a cold district, the coolant preferably further includes an antifreeze. The antifreeze is preferably at least one selected from the group consisting of ethylene glycol and propylene glycol. The content of the antifreeze in the coolant is preferably 25 to 60 parts by weight per 100 parts by weight of water.

More preferably, the coolant further includes a foaming accelerator that starts foaming at a temperature of 100° C. or more. The inclusion of a foaming accelerator facilitates foaming by the surfactant.

Examples of the foaming accelerator include a first foaming accelerator capable of foaming at a second temperature of 100° C. or more and less than 200° C., and a second foaming accelerator capable of foaming at a third temperature of 200° C. or more.

The first foaming accelerator may be, for example, a material that releases water of crystallization or decomposes to generate gas at the second temperature of 100° C. or more and less than 200° C. The first foaming accelerator is exemplified by silicates having water of crystallization, such as sodium silicate and potassium silicate. These may be used singly or in combination of two or more. Such silicates release water of crystallization at a high temperature of 100° C. or more and less than 200° C., causing the coolant to foam. Further, the release of water of crystallization relatively increases the amount of water in the coolant, and thus enhances the cooling effect.

The silicates having water of crystallization have a composition represented by, for example, the formula:

M₂O.nSiO.xH₂O, where M is at least one of Na and K. When M is Na, n is 0.5 to 4. When M is K, n is 0.4 to 4. In the formula, x represents the amount of water of crystallization, and can be any value, depending on the amount of water of crystallization. For example, in the case of sodium metasilicate, M=Na and n=1. In the case of potassium metasilicate, M=K and n=1.

The second foaming accelerator may be, for example, a material that decomposes to generate gas at the third temperature of 200° C. or more. The second foaming accelerator is exemplified by at least one selected from the group consisting of aluminum hydroxide, magnesium hydroxide, calcium carbonate, magnesium carbonate, and alum. These materials decompose to generate water vapor at the third temperature, causing the coolant to foam. Further, since water is produced through thermal decomposition of the second foaming accelerator, the amount of water in the coolant is relatively increased, and the cooling effect is enhanced.

The foaming accelerators may be used singly or in combination of two or more. Particularly preferable is a combination of the first foaming accelerator and the second foaming accelerator. By using the first foaming accelerator in combination with the second foaming accelerator, it is possible to facilitate foaming by the surfactant and supply water for cooling the battery, continuously in a wide range of temperatures.

Specifically, it is preferable to combine sodium silicate with aluminum hydroxide and/or magnesium hydroxide. Sodium silicate releases water of crystallization when heated to about 130 to 150° C., and the released water evaporates into water vapor, causing foaming. In contrast, aluminum hydroxide is thermally decomposed to produce water vapor when heated to about 200 to 300° C. Magnesium hydroxide is thermally decomposed to produce water vapor when heated to about 400° C. or more. By combining as above, when the temperature of the battery is raised higher than the temperature at which sodium silicate can release water vapor, thermal decomposition of aluminum hydroxide and/or magnesium hydroxide occurs, to generate further water vapor.

The content of the foaming accelerator in the coolant is preferably 1 to 40 parts by weight per 100 parts by weight of the total of the surfactant and water. The content of the foaming accelerator as used here is a total amount of the first foaming accelerator and the second foaming accelerator. In the case where the foaming accelerator contains bound water, the content of the foaming accelerator is the amount excluding the amount of bound water. It should be noted that the “bound water” is water bound by some interaction to the foaming accelerator, and is not water of crystallization retained in the crystal lattice.

When the content of the foaming accelerator in the coolant is 1 part by weight or more per 100 parts by weight of the total of the surfactant and water, the coolant is allowed to foam more effectively. When the content of the foaming accelerator in the coolant is 40 parts by weight or less per 100 parts by weight of the total of the surfactant and water, the effect by surfactant and water can be more effectively ensured.

The battery pack can be produced by a method including the steps of, for example,

(A) enclosing a coolant in a cooling container to form a cooling member, and

(B) arranging a battery and the cooling member such that a surfactant released from a releasing port formed in the cooling container can spread on a principal surface of the battery.

In the step (A), for example, a coolant is charged in a cooling container through an opening thereof, and then the opening is sealed by, for example, thermal welding.

In the case of using a coolant including a surfactant and a metallic soap, the coolant may be prepared prior to the step (A). For example, the coolant is obtained by mixing water with a surfactant or with a surfactant and a metallic soap. To the coolant, a foaming accelerator and other components may be added as needed.

In the case where an aqueous solution obtained by mixing water with a surfactant and a foaming accelerator shows strong alkalinity, it is preferable to handle the surfactant and the foaming accelerator while they are enclosed in a rein film bag of, for example, polyethylene. In this case, the bag may be accommodated together with water and a metallic soap in a cooling container.

In the step (B), for example, a battery and the cooling member prepared in the step (A) are fixed in a predetermined arrangement. The fixing method is not particularly limited, and the battery and the cooling member may be fixed with an adhesive or binding belt. Alternatively, a housing may be used, in which case the battery and the cooling member are fixedly accommodated in the housing.

In the battery pack shown in FIGS. 1 and 2, the sheet-like cooling members 5a and 5b are disposed in the recesses 6a and 6b of the square plate-like lid. The batteries 3a and 3b are placed in the bottomed prismatic tubular case body 2a, and then, the peripheral portion of the square plate-like lid 2b is placed on the step provided at the opening end of the bottomed prismatic tubular case body 2a. The cooling member 5a is thus sandwiched between the lid 2b and the battery 3a. Thereafter, the fitted portion between the case body 2a and the lid 2b is thermally welded, to integrate the case body 2a and the lid 2b into one unit. In such a manner, the batteries 3a and 3b and the cooling members 5a and 5b are accommodated in the case body 2a. The cooling members 5a and 5b each include a cooling container being a pouch body and a coolant enclosed in the container.

As for a housing, for example, the peripheral portion of the square plate-like lid 2b is placed on the step provided at the opening end of the bottomed prismatic tubular case body 2a, and the fitted portion therebetween is thermally welded to integrate the case body 2a and the lid 2b into one unit, whereby the housing 2 is prepared.

The housing is formed by, for example, resin molding. The resin material used for molding of the housing is preferably a flame-retardant resin of V-0 or higher of UL-94 standard. “A Guide to the Safe Use of Secondary Lithium Ion Batteries in Notebook-type Personal Computers” (Japan Electronics and Information Technology Industries Association, Battery Association of Japan) recommends using the above flame-retardant resin as the resin material of the housing. A preferable example of the flame-retardant resin is a polymer material having been subjected to flame-retardant treatment. The polymer material may be at least one selected from the group consisting of, for example, polycarbonate, polypropylene and, polyethylene terephthalate. The flame-retardant treatment may be performed by, for example, adding a flame-retardant agent to the polymer material.

### EXAMPLES

The present invention is specifically described below with reference to Examples and Comparative Examples. It should be noted, however, the present invention is not limited to the below-described Examples.

In order to evaluate the safety of the battery pack of the present invention, evaluation packs having the same configuration as the battery pack as shown in FIGS. 1 and 2 except that they includes metal columnar bodies in place of the batteries were produced in the following manner.

### Example 1

### (1) Production of Coolant

A coolant A was prepared by mixing 0.04 g of surfactant, 0.004 g of metallic soap, and 4 g of water. The surfactant used here was sodium oleate (available from Wako Pure Chemical Industries, Ltd.). The metallic soap used here was calcium stearate (available from Wako Pure Chemical Industries, Ltd.). The coolant A was enclosed in an amount of 2 g in a cooling container made of a 0.04-mm-thick polypropylene film and shaped in the form of a pouch body (i.e., obtained by bonding the peripheries of two sheets of film). A cooling member A (length: 65 mm, width: 20 mm, thickness: 1.4 mm) was thus produced.

### (2) Production of Evaluation Pack

In place of the batteries 3a and 3b, two iron columnar bodies (length: 65 mm, diameter: 18 mm) were placed with the axis directions thereof being parallel to each other, in a polycarbonate case body having an internal space of 67 mm in length, 41 mm in width, and 40 mm in depth, and a wall thickness of 1 mm. The clearance between the two columnar bodies was set to 1.1 mm. An evaluation pack A was thus produced.

Specifically, two cooling members A were mounted in the recesses of the lid, and two cylindrical bodies were placed in the case body. Then, the lid was fitted to the opening of the case body. For the below-described evaluation, the fitted portion between the case body and the lid was not thermally welded.

### Example 2

A coolant B was prepared by mixing 0.04 g of surfactant, 0.01 g of metallic soap, and 4 g of water. The surfactant used here was straight-chain dodecyl benzene sodium sulfonate (available from Wako Pure Chemical Industries, Ltd.). The metallic soap used here was calcium stearate (available from Wako Pure Chemical Industries, Ltd.).

A cooling member B was produced in the same manner as in Example 1, except that the coolant B was used in place of the coolant A. An evaluation pack B was produced in the same manner as in Example 1, except that the cooling member B was used in place of the cooling member A.

### Example 3

A coolant C was prepared by mixing 0.08 g of surfactant, 0.004 g of metallic soap, 4 g of water, and 0.08 g of foaming accelerator. The surfactant used here was sodium polyoxyethylene alkyl ether sulfate (EMAL 20CM, available from Kao Corporation). The metallic soap used here was calcium stearate (available from Wako Pure Chemical Industries, Ltd.). The foaming accelerator used here was sodium silicate (No. 3 silicate soda, available from Osaka Keisou Co., Ltd.).

A cooling member C was produced in the same manner as in Example 1, except that the coolant C was used in place of the coolant A. An evaluation pack C was produced in the same manner as in Example 1, except that the cooling member C was used in place of the cooling member A.

### Example 4

A cooling member D was produced in the same manner as in Example 1, except that 2 g of water was used as a coolant D in place of the coolant A.

An evaluation pack D was produced in the same manner as in Example 1, except that the cooling member D was used in place of the cooling member A.

With regard to each of the evaluation packs A to D of Examples 1 to 4, the lid was taken away, and one of the two cylindrical bodies (a first cylindrical body) was taken out from the case body. A heating element of a ceramic heater (MS-M5, available from Sakaguchi E.H. VOC Corp.) was brought into contact with the cylindrical body, and a pair of leads extending from the heating element was connected to a power source having a terminal-to-terminal voltage of 6 V, to heat until the temperature of the cylindrical body reached 600° C. The temperature of the cylindrical body was measured using a thermocouple.

The cylindrical body heated to 600° C. was placed back to the case body, and the lid with the cooling member mounted thereon was attached to the case body. As this time, a binding member was attached around the battery pack, as a handy way to prevent the lid from being detached from the case body upon expansion of the cooling member. The temperature of one of the cylindrical bodies was measured at 100 seconds after the cooling member had contacted the heated cylindrical body, and the temperature of the other cylindrical body (a second cylindrical body) was measured at 300 seconds after the cooling member had contacted the heated cylindrical body, both of which were measured using a thermocouple. The results are shown in Table 1.

TABLE 1

| | | Temperature of first | Temperature of second |
|---|---|---|---|
| | Evaluation | cylindrical body | cylindrical body |
| | pack | (° C.) | (° C.) |
| Example 1 | A | 435 | 104 |
| Example 2 | B | 430 | 98 |
| Example 3 | C | 408 | 86 |
| Example 4 | D | 493 | 130 |

In all of the evaluation packs A to D of Examples 1 to 4, the first cylindrical body was cooled well. In the evaluation packs A to C, the heated first cylindrical body was cooled more effectively than in the evaluation pack D, and the heat transfer to the second columnar body was suppressed, indicating that higher safety was achieved.

Although sodium oleate was used as the surfactant in Example 1, other carboxylic acid-type surfactants such as sodium laurate, sodium myristate, sodium palmitate, and sodium stearate may be used with similar effects to those obtained in Example 1.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

In the battery pack according to the present invention, if abnormal heat generation occurs in a battery, the battery can be cooled efficiently and reliably. The battery pack according to the present invention, therefore, can be suitably used as a power source for portable devices such as notebook personal computers and cellular phones, and also as a driving power source for large-sized electric vehicles.

### REFERENCE SIGNS LIST

1 Battery pack
2 Housing
2a Case body
2b Lid
3a, 3b Battery
4a, 4b Concave
5a, 5b, 15 Cooling member
6a, 6b Recess
7 Resin member
8 Cooling container
8a, 8b, 18a, 18b Principal surface of cooling container
10 Coolant
11a, 21a, 21b, 31a, 31b, 41a, 41b Principal surface of battery

1. A battery pack comprising a battery and a cooling member for cooling the battery, wherein
the cooling member comprises a coolant and a container enclosing the coolant,
the container is capable of having a releasing port for releasing the coolant at a first temperature of 100° C. or more, and
the cooling member is arranged at a position that allows the coolant released from the releasing port of the container to spread on a principal surface of the battery.

2. The battery pack in accordance with claim 1, wherein the coolant includes water, a surfactant, and a metallic soap.

3. The battery pack in accordance with claim 2, wherein the surfactant has, in the molecule thereof, at least one hydrophilic group selected from the group consisting of carboxyl group, sulfonic acid group, sulfuric acid ester groups, phosphoric acid ester groups, and salts thereof.

4. The battery pack in accordance with claim 2, wherein the metallic soap is hardly soluble in water, and is an alkaline earth metal salt or a zinc salt of a higher fatty acid.

5. The battery pack in accordance with claim 2, wherein a content of the surfactant in the coolant is 0.1 to 20 parts by weight per 100 parts by weight of water.

6. The battery pack in accordance with claim 2, wherein a content of the metallic soap in the coolant is 0.01 to 5 parts by weight per 100 parts by weight of water.

7. The battery pack in accordance with claim 2, wherein the coolant further includes at least one foaming accelerator selected from the group consisting of a first foaming accelerator capable of foaming at a second temperature of 100° C. or more and less than 200° C., and a second foaming accelerator capable of foaming at a third temperature of 200° C. or more.

8. The battery pack in accordance with claim 7, wherein the first foaming accelerator is a silicate having water of crystallization, and the silicate is at least one selected from the group consisting of sodium silicate and potassium silicate.

9. The battery pack in accordance with claim 7, wherein the second foaming accelerator is at least one selected from the group consisting of aluminum hydroxide, magnesium hydroxide, calcium carbonate, magnesium carbonate, and alum.

10. The battery pack in accordance with claim 1, wherein the principal surface of the container is parallel to and in contact with the principal surface of the battery.

11. The battery pack in accordance with claim 10, wherein
in normal use, the cooling member is positioned vertically above or on the battery, and
the principal surface of the container forms an angle of 80 to 110° with respect to the vertical direction.

12. The battery pack in accordance with claim 10, wherein the battery is cylindrical, and
the principal surface of the battery is a side surface of the battery.
